(19) United States
(12) Patent Application Publication
(10) Pub. No.: US 2025/0308107 A1
(43) Pub. Date: Oct. 2, 2025

(54) Kaplan-Meier Digitizer for Automating Kaplan-Meier Curve Analysis

(71) Applicant: Bristol-Myers Squibb Company, Princeton, NJ (US)

(72) Inventors: Gengyuan Liu, Lawrenceville, NJ (US); Md Shamsuzzaman, Lawrenceville, NJ (US); Mariann Micsinai Balan, Lawrenceville, NJ (US)

(73) Assignee: Bristol-Myers Squibb Company, Princeton, NJ (US)

(21) Appl. No.: 19/094,484

(22) Filed: Mar. 28, 2025

Related U.S. Application Data
(60) Provisional application No. 63/572,645, filed on Apr. 1, 2024.

(51) Int. Cl. G06T 11/20; G06T 7/11; G06T 7/73; G06T 7/90; G06T 11/00

(52) U.S. Cl. CPC G06T 11/206; G06T 7/11; G06T 7/73; G06T 7/90; G06T 11/001; G06T 2200/28; G06T 2207/10024; G06T 2207/20132

(57) ABSTRACT

A method includes receiving an input image containing a graphical Kaplan-Meier (KM) plot and processing the input image to convert the graphical KM plot into a three-dimensional (3D) array. The method also includes processing the 3D array to generate a black pixel matrix mask and a colored pixel matrix mask, processing the black pixel matrix mask to identify pixel coordinates that define x- and y-axis of the graphical KM plot, cropping the colored pixel matrix mask based on the identified pixel coordinates, and processing the cropped colored pixel matrix to segment the colored pixels from the cropped colored pixel matrix mask into respective groups of clustered pixels. The method also includes processing each respective group of clustered pixels to generate a respective digitized representation of a corresponding KM curve and generating a digitized KM plot based on the respective digitized representation generated for each corresponding KM curve.

### CROSS-REFERENCE TO RELATED APPLICATIONS

This U.S. patent application claims priority under 35 U.S.C. § 119(e) to U.S. Provisional Application 63/572,645, filed on Apr. 1, 2024. The disclosure of this prior application is considered part of the disclosure of this application and is hereby incorporated by reference in its entirety.

### TECHNICAL FIELD

This disclosure relates to a Kaplan-Meier (KM) digitizer for automating KM curve analysis.

### BACKGROUND

Survival analysis is a statistical method used extensively in clinical research to analyze time-to-event data, crucial for understanding patient outcomes over time. Central to survival analysis is the Kaplan-Meier (KM) curve, introduced by Edward L. Kaplan and Paul Meier in 1958, which provides a graphical method of displaying survival data. The KM curve estimates the survival probability over time, accounting for censored data, which occurs when a patient's final outcome is unknown at the study's end. This method has become a staple for reporting in clinical trials, observational studies, and other research endeavors in the medical field.

### SUMMARY

One aspect of the disclosure provides a computer-implemented method that when executed on data processing hardware causes the data processing hardware to perform operations that include receiving an input image containing a graphical Kaplan-Meier (KM) plot of one or more KM curves. The graphical KM plot has an x-axis and a y-axis orthogonal to the x-axis. The operations also include processing the input image to convert the graphical KM plot into a three-dimensional (3D) array representing a color of each pixel from the graphical KM plot by a respective 3D vector, and processing the 3D array to generate: a black pixel matrix mask by converting all white pixels to pure white and all other pixels to pure black; and a colored pixel matrix mask by converting all black, grey, and white pixels to pure white. The operations also include processing the black pixel matrix mask to identify pixel coordinates that define the x-axis and the y-axis of the graphical KM plot, cropping the colored pixel matrix mask based on the identified pixel coordinates that define the x-axis and the y-axis of the graphical KM plot, and processing the cropped colored pixel matrix to segment the colored pixels from the cropped colored pixel matrix mask into respective groups of clustered pixels. Here, each respective group of clustered pixels is associated with a different respective color. The operations also include processing each respective group of clustered pixels that represents a corresponding KM curve of the one or more KM curves of the graphical KM plot to generate a respective digitized representation of the corresponding KM curve, and generating a digitized KM plot based on the identified pixel coordinates that define the x-axis and the y-axis of the graphical KM plot and the respective digitized representation generated for each corresponding KM curve of the one or more KM curves of the graphical KM plot.

Implementations of the disclosure may include one or more of the following optional features. In some implementations, the cropped colored pixel matrix mask retains only a region of the graphical KM plot that is encompassed by the positions of the x-axis and the y-axis so that the cropped colored pixel matrix exclusively contains the one or more KM curves of the graphical KM plot. In some examples, the operations further include processing each respective group of clustered pixels to identify which respective group of clustered pixels represent a background of the graphical KM plot and which one or more respective groups of clustered pixels represent corresponding ones of the one or more KM curves of the graphical KM plot.

Processing the black pixel matrix mask to identify pixel coordinates that define the x-axis and the y-axis of the graphical KM plot may further include processing the black pixel matrix mask to identify and delineate tick mark positions along both the x-axis and the y-axis of the graphical KM plot. Here, generating the digitized KM plot may be further based on the tick mark positions identified and delineated along both the x-axis and the y-axis of the graphical KM plot.

In some implementations, processing the cropped colored pixel matrix to segment the colored pixels from the cropped colored pixel matrix mask into respective groups of clustered pixels comprises includes flattening the cropped colored pixel matrix mask into a vector of color code vectors and processing the vector of color code vectors using a K-means clustering for clustering the respective colors associated with the one or more KM curves into the respective groups of clustered pixels. Each respective group of clustered pixels may have a centroid defining the different respective color associated with the pixels in the respective group of clustered pixels. In these implementations, processing each respective group of clustered pixels that represents the corresponding KM curve of the one or more KM curves of the graphical KM plot may optionally include determining an average Euclidean distance between the pixels within the respective group of clustered pixels, identifying a top-N respective groups of clustered pixels having the lowest average Euclidean distances to represent each of the one or more KM curves, and processing the top-N respective groups of clustered pixels to generate the respective digitized representation of each corresponding KM curve of the one or more KM curves. Here, N may be equal to a number of the one or more KM curves of the graphical KM plot.

Generating the digitized KM plot may include, for each corresponding pixel point in the respective digitized representation generated for the corresponding KM curve: applying a regression model over a window encompassing a predetermined number pixels before and a the predetermined number of pixels after the corresponding pixel point to estimate a reference y value for the corresponding pixel point; calculating a mean and standard deviation of discrepancies between the reference y value and the counterpart digitized y value extracted from the respective digitized representation; and removing the corresponding pixel point from the respective digitized representation when the standard deviation from the mean exceeds a threshold number of standard deviations. Each KM curve of the one or more KM curves of the graphical KM plot depicts survival probability over time for a respective group of subjects.

In some examples, the operations also include executing an independent patient data (TPD) extraction process that uses number at risk data obtained from the graphical KM plot to extract IPD from the digitized KM plot. In these examples, the operations may also include generating a digitized IPD plot that conveys the IPD extracted from the digitized KM plot.

Another aspect of the disclosure provides a system that includes data processing hardware and memory hardware storing instructions that when executed on the data processing hardware causes the data processing hardware to perform operations. The operations include receiving an input image containing a graphical Kaplan-Meier (KM) plot of one or more KM curves. The graphical KM plot has an x-axis and a y-axis orthogonal to the x-axis. The operations also include processing the input image to convert the graphical KM plot into a three-dimensional (3D) array representing a color of each pixel from the graphical KM plot by a respective 3D vector, and processing the 3D array to generate: a black pixel matrix mask by converting all white pixels to pure white and all other pixels to pure black; and a colored pixel matrix mask by converting all black, grey, and white pixels to pure white. The operations also include processing the black pixel matrix mask to identify pixel coordinates that define the x-axis and the y-axis of the graphical KM plot, cropping the colored pixel matrix mask based on the identified pixel coordinates that define the x-axis and the y-axis of the graphical KM plot, and processing the cropped colored pixel matrix to segment the colored pixels from the cropped colored pixel matrix mask into respective groups of clustered pixels. Here, each respective group of clustered pixels is associated with a different respective color. The operations also include processing each respective group of clustered pixels that represents a corresponding KM curve of the one or more KM curves of the graphical KM plot to generate a respective digitized representation of the corresponding KM curve, and generating a digitized KM plot based on the identified pixel coordinates that define the x-axis and the y-axis of the graphical KM plot and the respective digitized representation generated for each corresponding KM curve of the one or more KM curves of the graphical KM plot.

This aspect of the disclosure may include one or more of the following optional features. In some implementations, the cropped colored pixel matrix mask retains only a region of the graphical KM plot that is encompassed by the positions of the x-axis and the y-axis so that the cropped colored pixel matrix exclusively contains the one or more KM curves of the graphical KM plot. In some examples, the operations further include processing each respective group of clustered pixels to identify which respective group of clustered pixels represent a background of the graphical KM plot and which one or more respective groups of clustered pixels represent corresponding ones of the one or more KM curves of the graphical KM plot.

Processing the black pixel matrix mask to identify pixel coordinates that define the x-axis and the y-axis of the graphical KM plot may further include processing the black pixel matrix mask to identify and delineate tick mark positions along both the x-axis and the y-axis of the graphical KM plot. Here, generating the digitized KM plot may be further based on the tick mark positions identified and delineated along both the x-axis and the y-axis of the graphical KM plot.

In some implementations, processing the cropped colored pixel matrix to segment the colored pixels from the cropped colored pixel matrix mask into respective groups of clustered pixels comprises includes flattening the cropped colored pixel matrix mask into a vector of color code vectors and processing the vector of color code vectors using a K-means clustering for clustering the respective colors associated with the one or more KM curves into the respective groups of clustered pixels. Each respective group of clustered pixels may have a centroid defining the different respective color associated with the pixels in the respective group of clustered pixels. In these implementations, processing each respective group of clustered pixels that represents the corresponding KM curve of the one or more KM curves of the graphical KM plot may optionally include determining an average Euclidean distance between the pixels within the respective group of clustered pixels, identifying a top-N respective groups of clustered pixels having the lowest average Euclidean distances to represent each of the one or more KM curves, and processing the top-N respective groups of clustered pixels to generate the respective digitized representation of each corresponding KM curve of the one or more KM curves. Here, N may be equal to a number of the one or more KM curves of the graphical KM plot.

Generating the digitized KM plot may include, for each corresponding pixel point in the respective digitized representation generated for the corresponding KM curve: applying a regression model over a window encompassing a predetermined number pixels before and a the predetermined number of pixels after the corresponding pixel point to estimate a reference y value for the corresponding pixel point; calculating a mean and standard deviation of discrepancies between the reference y value and the counterpart digitized y value extracted from the respective digitized representation; and removing the corresponding pixel point from the respective digitized representation when the standard deviation from the mean exceeds a threshold number of standard deviations. Each KM curve of the one or more KM curves of the graphical KM plot depicts survival probability over time for a respective group of subjects.

In some examples, the operations also include executing an independent patient data (IPD) extraction process that uses number at risk data obtained from the graphical KM plot to extract IPD from the digitized KM plot. In these examples, the operations may also include generating a digitized IPD plot that conveys the IPD extracted from the digitized KM plot.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a schematic view of an example system for automating the digitization of Kaplan-Meier (KM) curves and extracting individual patient data (IPD) from the KM curves.

FIG. 2A is an example KM plot depicting overall survival for two groups of patients each represented by a respective KM curve.

FIG. 2B is an example of a black pixel matrix mask that masks black pixels converted from the KM plot of FIG. 2A.

FIG. 2C is an example of a colored pixel matrix mask that masks colored pixels converted from the KM plot of FIG. 2A.

FIG. 2D is an example of a digitized version of the KM plot of FIG. 2A digitized by the system of FIG. 1.

FIG. 2E is an example of the digitized version of the KM plot depicting digitized outcomes based on extracted IPD.

FIG. 3 is an example of the black pixel matrix mask of FIG. 2B depicting the x-axis, y-axis, and tick marks along the x- and y-axis identified by an x-y axis tick mark identification process.

FIG. 4 is a schematic view of a colored mask cropper of the system of FIG. 1 generating a cropped colored pixel matrix mask.

FIG. 5 is a flowchart depicting a curve segmentation process performed by the system of FIG. 1 for segmenting KM curves by color based on the cropped color pixel matrix mask generated by the colored mask cropper of FIG. 4.

FIG. 6 is a flowchart depicting a curve digitization routine performed by the system of FIG. 1 for generating digitized representations of KM curves.

FIG. 7 is a flowchart of an independent patient data (IPD) extraction process for extracting IPD from a digitized KM plot.

FIG. 8 is an example table of digitized data conveyed in a digitized KM plot that includes respective digitized survival values associated with digitized time points.

FIG. 9 is an example table of digitized data conveyed in a digitized KM plot that includes respective digitized survival values, number of events and number of censors associated with digitized time points.

FIGS. 10A and 10B of independent patient data (IPD) extracted for respective groups of subjects.

FIG. 11 is a flowchart of an example arrangement of operations for a method of digitizing a KM plot of one or more KM curves.

FIG. 12 is a schematic view of an example computing device that may be used to implement the systems and methods described herein.

Like reference symbols in the various drawings indicate like elements.

### DETAILED DESCRIPTION

Survival analysis is a cornerstone of clinical research, with the Kaplan-Meier (KM) curve being a key tool for estimating survival probability over time. The full potential of KM curves is often underutilized due to the difficulty in extracting detailed patient-level data from published graphs. Notably, an ability to extract independent patient data (IPD) from KM curves enables more nuanced and individualized analysis. Access to IPD allows for meta-analysis and pooled analyses, thereby offering a deeper understanding of treatment effects across different patient subgroups and studies. The ability to extract IPD from KM curves and gain access to this granularity enhances predictive accuracy of survival models to thereby guide clinical decision-making and directions of research.

Despite the value that IPD affords, conventional approaches rely on manually extracting IPD from KM curves, which are extremely labor-intensive, prone to error, and often times impractical, particularly in scenarios where multiple curves are present in a single KM plot. While some conventional techniques rely on semi-automated software to provide a solution for digitizing KM curves and extracting IPD therefrom, these techniques still require significant user intervention that are time-consuming, lack precision, and are unable to adequately process complex curves, especially in scenarios when multiple KM curves are intertwined and/or exhibit varying line styles and backgrounds. As such, these conventional techniques introduce a degree of subjectivity that may affect the reliability and reproducibility of the extracted data.

Implementations herein are directed toward a KM digitizer that automates a digitization process for digitizing KM curves from an input image containing a KM plot of one or more KM curves, while ensuring accuracy and reproducibility of IPD extracted from the digitized KM curves. Unlike the aforementioned manual and semi-automated techniques, the KM digitizer requires minimal initial input by a user by leveraging advanced computational techniques to accurately digitize the KM curves from the input image, even in the presence of noise, varying line styles, and overlapping data points. By automating the digitization process of KM curves, the KM digitizer opens new avenues for meta-analysis and comparative effectiveness research by facilitating the extraction of IPD from multiple KM curves efficiently and accurately. As will become apparent, the KM digitizer provides solutions to refine treatment strategies, improve patient outcomes, and contribute to the advancement of personalized medicine.

More specifically, implementations are directed toward the KM digitizer providing an automated seven (7) step digitization process to enable the navigation of complex graphical backgrounds, accurately trace curve paths, and facilitate the extraction of IPD from images containing graphical KM plots provided as input to the KM digitizer. During a first step of the digitization process, a three-dimensional (3D) array converter converts an input image containing a graphical KM plot into a 3D array that represents each pixel's color from the graphical KM plot by a respective 3D vector such that the visual information for each pixel is effectively captured in a structured form.

A second step of the digitization process processes the respective 3D vectors represented by the 3D array to assign one of four possible colors indicators to each pixel: zero (0) for black, one (1) for white, two (2) for colored, and three (3) for grey. Thereafter, a black pixel mask converter generates a black pixel matrix mask by converting all white pixels to pure white and all other pixels to pure black while a colored pixel mask converter generates a colored pixel matrix mask by converting all black, grey, and white pixels to pure white. In subsequent steps, the black pixel matrix mask enables the digitization process to first identify the x-axis and y-axis of the KM plot and the colored pixel mask is instrumental for ultimately digitizing the KM curves in the original graphical KM plot.

During a third step of the digitization process, a plot axis identifier processes the black pixel matrix mask to identify the x-axis and the y-axis of the KM plot by locating the longest continuous black lines formed by the black pixels in the black pixel matrix mask. Here, the longest continuous black line extending horizontally represents the x-axis and the longest continuous black line extending vertically represents the y-axis. After the x-axis and the y-axis are identified, the plot axis identifier is further configured to perform a one-dimensional (1D) clustering technique to identify and delineate tick marks along both the x-axis and the y-axis. The plot axis identifier may output axis-tick mark coordinates depicting the positions of the x-axis, the y-axis, and the tick marks identified along both the x-axis and the y-axis.

During a fourth step of the digitization process, a colored mask cropper receives, as input, the axis-tick mark coordinates output by the plot axis identifier and the colored pixel matrix mask generated by the colored pixel mask converter and generates, as output, a cropped colored pixel matrix mask. Notably, as the second step of the digitization process generated both the colored pixel matrix mask and the black pixel matrix mask alongside one another, the dimensions of the original graphical KM plot are preserved to allow for the seamless application of the x- and y-axis positions identified in the black pixel matrix mask to the colored pixel matrix mask. As such, the colored mask cropper crops the colored pixel matrix mask to retain only a region encompassed by the x- and y-axis positions. The cropped colored pixel matrix mask exclusively contains the digitization-relevant colored KM curves.

During a fifth step of the digitization process, a curve segmentation routine initially processes the cropped colored pixel matrix mask to flatten the cropped colored pixel matrix mask into a vector of color (e.g., RGB) code vectors and then uses K-means clustering for clustering the respective colors associated with the KM curves in the cropped colored pixel matrix mask into respective groups. The curve segmentation routine may require that a number of clusters be set equal to the number of KM curves present in the graphical KM plot incremented by one to account for the white background. Through K-means clustering, the curve segmentation routine categorizes pixels from the cropped colored pixel matrix mask into the distinct respective groups with each respective group of clustered pixels having a centroid that defines a general color of the pixels. The curve segmentation routine may identify the group of clustered pixels representing the background based on the characteristics of this group typically having the largest number of clustered pixels and each of the clustered pixels having a color close to white. For the remaining groups of clustered pixels, the curve segmentation routine may distinguish the those groups of clustered pixels that contain the pixels of actual KM curves from noise by comparing an average Euclidean distance between the pixels within the cluster and their clustered centroid (e.g., center). That is, groups having clustered pixels with a lower average Euclidean distance are indicative of actual KM curves, while those clusters having a higher variance are likely attributed to noise. As such, the curve segmentation routine will output the top-N respective groups of clustered pixels having the smallest average Euclidean distance to represent each of the KM curves. Here, “N” is equal to the number of KM curves in the graphical KM plot.

During a sixth step of the digitization process, a curve digitizer performs a pixel-by-pixel analysis on each respective group of clustered pixels segmented by the curve segmentation routine to generate a respective digitized representation of the corresponding KM curve represented by the respective group of clustered pixels. Namely, using the coordinates from the cropped colored pixel matrix mask, the curve digitizer assigns a top left pixel from the respective group of clustered pixels as a reference origin point and then determines the position of each pixel in relation to this origin. Each pixel point of reference may serve as an anchor point where the curve digitizer identifies a predefined number of nearest pixels to the anchor point that are within the same color group located to the right and below the anchor point. The predefined number of nearest pixels identified may be considered candidate points for the subsequent point of the corresponding KM curve, with those having distances from the anchor point exceeding a threshold being excluded as outliers from the curve. After exclusion of any outlier pixels, the positions of the remaining pixels may be averaged to establish the subsequent point on the corresponding KM curve. The subsequent point on the KM curve will serve as the anchor point and curve digitizer repeats the process in an iterative fashion to determine each point on the corresponding KM curve. Notably, when two or more points established along the same curve have a same x-coordinate value, the curve digitizer will retain only the point that is associated with a highest y-coordinate value. Lastly, the curve digitizer merges the digitized results from each respective colored group of clustered pixels into a combined coordinate data frame based on the x-coordinate positions. Here, the combined coordinate data frame serves as a composite digitization representation of all the KM curves in the original graphical KM plot.

A seventh and final step of the digitization process receives the combined coordinate data frame (e.g., composite digitization representation of the KM curves) and the axis-tick mark coordinates identified during the third step, and applies a regression model to generate a digitized KM plot. More specifically, a moving window regression technique is applied to remove residual outliers that still persist in the combined coordinate data frame so that the digitized KM plot is sufficiently robust. For each corresponding point in each digitized curve, a window encompassing up to 20 pixels before and 20 pixels after the corresponding point is analyzed by applying the regression model to estimate a reference Y value for the corresponding point. The moving window regression technique may then aggregate the reference Y values by calculating a mean and standard deviation of discrepancies between the digitized Y values and their counterpart reference Y values. Here, outliers may be identified as those points whose deviation from the mean exceeds a threshold number of standard deviations (e.g., three standard deviations). The regression model may be based on the exponential decay survival model, thereby enabling employment of a linear regression approach upon logarithmic transformation of Y values.

Moreover, the seventh step of the digitization process is tasked with ensuring that the digitized KM curves are monotonically decreasing, a key characteristic that defines KM curves. To achieve KM curves that exhibit a non-increasing monotonicity, the digitization process analyzes the digitized Y values by adjusting any point whose Y value is less than that of its predecessor by aligning it with the nearest preceding Y value to provide corrected coordinate data for the digitized KM curves. Stated differently, the digitization process corrects a point on KM curve having a corresponding Y value that is less than the corresponding Y value of a point directly to its left by replacing the corresponding Y value with the value of the Y value corresponding to the point directly to the left. Thereafter, the digitization process uses the axis-tick mark coordinates and the corrected coordinate data for the digitized KM curves to convert the coordinates of the cropped colored pixel matrix mask to the coordinates of the original graphical KM plot contained in the input image that was input to the 3D array converter during the first step. The digitized KM plot output by the digitization process includes the converted coordinates associated with the original graphical KM plot to preserve the accuracy and integrity of the original KM curves.

After the digitization process is complete to provide the final digitized KM plot, implementations are further directed toward an IPD extraction process configured to extract IPD from the digitized KM plot. Notably, the IPD data extraction process may receive, as input, the final digitized KM plot generated by the digitization process as well as number at risk data obtained from the original KM plot, and generate, as output, a digitized IPD plot that conveys the IPD extracted from the digitized KM plot. Here, the number at risk data may include a number at risk table representing the number at risk data positioned below the x-axis of the original graphical KM plot. In some examples, the number at risk table is manually input to the IPD extraction process. In other examples, the original graphical KM plot is processed by performing optical character recognition to extract the number at risk table. The number at risk table may include each of the time points depicted along the x-axis of the original graphical KM plot, and for each KM curve in the original graphical KM plot, the number at risk table further indicates a number of individual that were still accounted for that have not yet experienced the event of interest at each of the time points. Therefore, the number at risk at any of the particular time points will be equal to the total number of subjects/patients remaining that have not experienced the event of interest or that are censored at the particular time point.

For each KM curve, the IPD extraction process determines a corresponding interval difference value between the number of individuals at each corresponding time point and the number of individuals at the immediately preceding time point. Notably, the IPD extraction process leaves a difference value for the initial time point blank since there is no immediately preceding time point. Moreover, each pair of adjacent time points represents a corresponding time interval associated with both the corresponding interval difference value and the corresponding raw event number. Thereafter, for each KM curve and each corresponding time point, the IPD extraction process determines a corresponding raw event value based on the number of individuals at the immediately preceding time point and the digitized survival value (Y-value) associated with the digitized x-value that is closest to the value of the corresponding time point. After obtaining the corresponding raw event value for each KM curve and each corresponding time point from the number at risk table, the IPD extraction process can determine a corresponding raw censor value for each KM curve and each corresponding time point by subtracting the corresponding raw event value from the corresponding interval difference value. The IPD extraction process may obtain a corresponding estimated censor value by rounding the corresponding raw censor value to the closest integer. Using the corresponding estimated censor value obtained for each KM curve and each corresponding time point, the IPD extraction process may determine a corresponding estimated event value by subtracting the corresponding estimated censor value from the corresponding interval difference value.

Acting under the assumption that the estimated censor values distribute evenly within each corresponding time interval for each KM curve, the IPD extraction process may then calculate a raw number at risk for each corresponding time point by subtracting both the estimated event and censor values obtained for the immediately preceding time point from a raw number at risk value calculated for the immediately preceding time point. Using the raw number at risk calculated for the corresponding time point, the IPD extraction process may calculate an accumulated event value of the corresponding time point and then determine a calculated number of events at the corresponding time point based on a difference between the accumulated event value of the corresponding time point and the accumulated event value of the immediately preceding time point. The IPD extraction process may determine a calculated number at risk value at each corresponding time point by updating the raw number at risk calculated for the corresponding time point based on the calculated number of events and corresponding censor value at the corresponding time point.

Lastly, the IPD extraction process may apply the number at risk table to adjust the calculated number at risk values at the corresponding time points for each KM curve. Namely, for each KM curve, the IPD extraction process compares the calculated number at risk value at each corresponding time point to the actual number at risk value at the corresponding time point obtained from the number at risk table. When the calculated number at risk value is greater than the actual number at risk value, the IPD extraction process adds the value of the mismatch difference to the accumulated event value of the immediately preceding time step and subtracts the mismatch from the calculated number at risk value. On the other hand, when the calculated number at risk value is less than the actual number at risk value, the IPD extract process subtracts a value of the mismatch difference from the estimated censor value at the corresponding time step. Notably, if the value of the mismatch difference is greater than the estimated censor value, the IPD extraction process will subtract any difference left after subtracting from the estimated censor value from the calculated number of events at the corresponding time point.

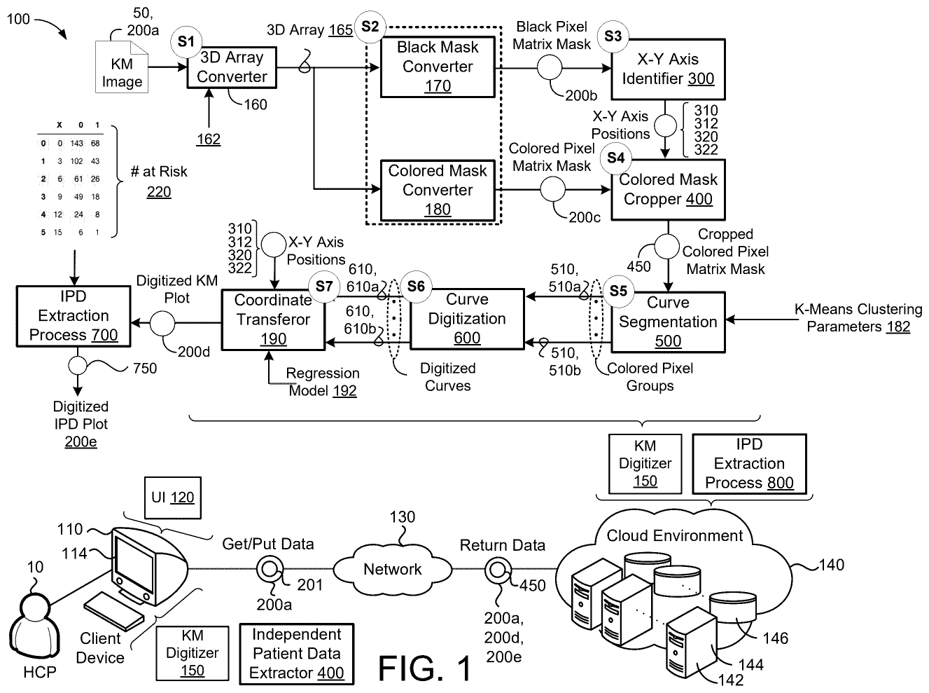

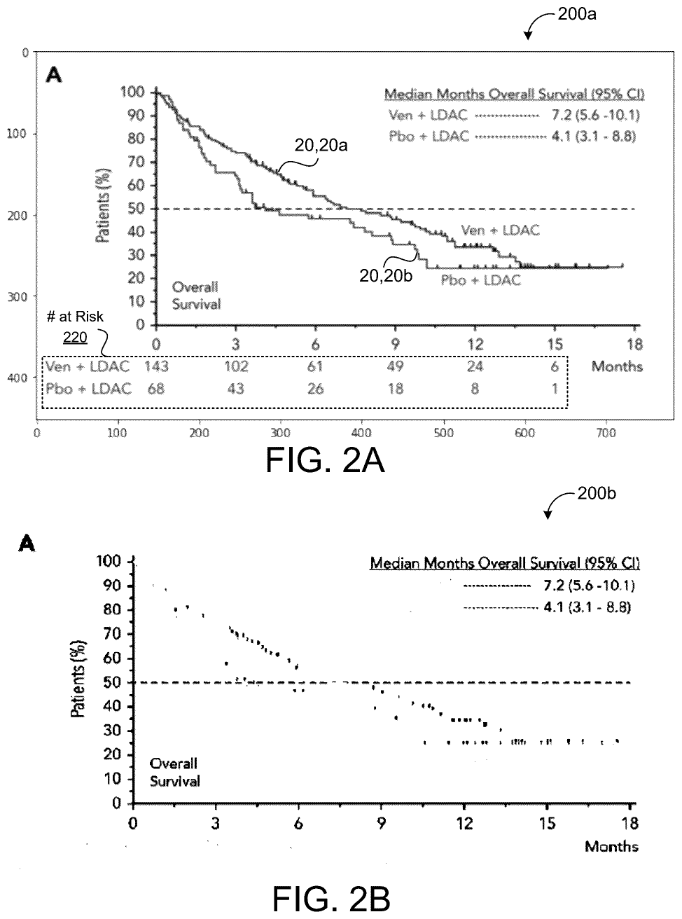

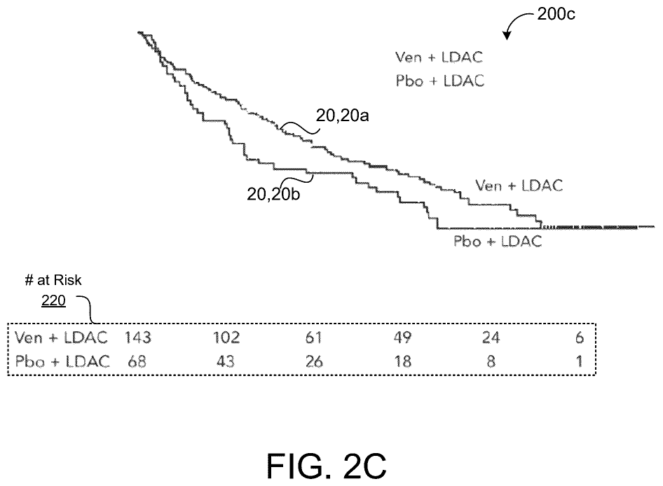

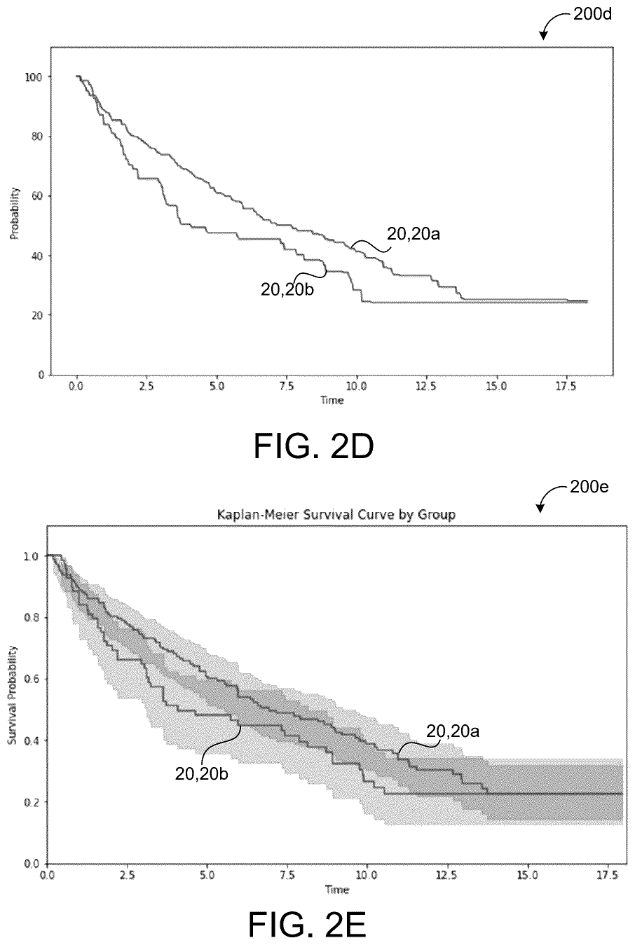

Referring to FIG. 1, in some implementations, a system 100 includes a client device 110 inputting a KM image 50 containing an original graphical KM plot 200a of one or more KM curves 20 (FIG. 2A) to a KM digitizer 150 for generating a digitized KM plot 200d of one or more digitized KM curves replicating the one or more KM curves 20 in the original graphical KM plot 200a. The KM image 50 input by the user may originate from published literature or websites. As such, the format of the KM image 50 may vary, encompassing screenshots, image files (JPEG, PNG, PDF), and may also include direct uniform resource locators (URLs). The KM digitizer 150 may apply the Python Imaging Library (Pillow) for processing images across all supported formats. In some examples, when the KM image 50 input by the user is accessed via input of a URL, the KM digitizer 150 undertake an initial pre-processing step that involves using the URL to retrieve the image as a byte object via an HTTP request, and then using Pillow for subsequent processing.

The client device 110 is associated with a user 10 such as a healthcare professional (HCP), who may communicate, via a network 130, with a remote system 140. The remote system 140 may be a distributed system (e.g., cloud environment) having scalable/elastic resources 142. The resources 142 include computing resources 144 (e.g., data processing hardware) and/or storage resources 146 (e.g., memory hardware). In some implementations, the remote system 140 executes the KM digitizer 150. Here, the client device 150 may access the KM digitizer 150 running on the remote system 140 and input, via a graphical user interface (GUI) 120 executing on the client device, the KM image 200a to the KM digitizer 150. The client device 110 may additionally or alternatively execute the KM digitizer to implement the ability to run the KM digitizer 150 on the client device 110 for generating the digitized KM plot 200d.

FIG. 2A shows an example of the original KM plot 200a for survival analysis having two KM curves 20a, 20b each depicting survival probability over time for a respective group of subjects/individuals. In some examples, the subjects include patients that participated in a clinical trial. The first KM curve 20a may be graphically represented by a first color (e.g., red) while the second KM curve 20b may be graphically represented by a different second color (e.g., blue). In some examples, the KM curves 20a, 20b are each represented by different line styles/patterns that differentiate the two curves 20a, 20b from one another. The y-axis of the KM plot 200a denotes survival probability (%) extending from a minimum y-value equal to zero (0) at the origin to a maximum y-value equal to 100-percent. The x-axis of the KM plot 200a denotes time (e.g., in months) extending from a minimum x-value equal to zero (0) at the origin to a maximum x-value equal to 18-months. Values for the time points may be incremented along the x-axis. For instance, the values 0, 3, 6, 9, 12, and 15 may indicate a corresponding number of months incremented along the x-axis.

In some examples, the KM plot 200a additionally provides number at risk data 220. The number at risk data 220 may include each of the time points incremented along the x-axis of the original graphical KM plot 200a, and for each corresponding KM curve 20 in the original graphical KM plot 200a, the number at risk data 220 further indicates a number of subjects in the respective group represented by the corresponding KM curve 20 that were still accounted for that have not yet experienced the event of interest at each of the time points. Therefore, the number at risk value for each respective group of subjects at each particular time point will be equal to the total number of subjects remaining from the respective group that have not experienced the event of interest or that are censored at the particular time point. In the example shown, the number at risk data 220 is represented as a table having columns for the time point values incremented along the x-axis and rows for each respective group of subjects with corresponding number at risk value for each respective group of subjects denoted in the corresponding column for each particular time point. Here, the first group of subjects represented by the first KM curve 20a includes number at risk values equal to 143, 102, 61, 49, 24, and 6 at corresponding ones of the particular point values of 0, 3, 6, 9, 12, and 15-months. Likewise, the second group of subjects represented by the second KM curve 20b includes number at risk values equal to 68, 43, 26, 18, 8, and 1 at corresponding ones of the particular point values of 0, 3, 6, 9, 12, and 15-months. In some examples, the KM plot 200a conveys the text associated with each respective group of subjects in the number at risk data 220 in a same color as the color of the respective KM curve 20. For instance, the number at risk data 220 may use a first color of text to indicate the number at risk values associated with the first group of subjects represented by the first KM curve 20a and a second color of text to indicate the number at risk values associated with the second group of subjects represented by the second KM curve 20b.

Referring back to FIG. 1, the KM digitizer 150 provides an automated seven (7) step digitization process for generating the digitized KM plot 200d of the digitized KM curves replicating KM curves 20a, 20b in the original graphical KM plot 200a. During a first step (S1) of the digitization process, the KM digitizer uses a three-dimensional (3D) array converter 160 to convert the input KM image 50 containing the graphical KM plot 200a into a 3D array 165 that represents each pixel's color from the graphical KM plot 200a by a respective 3D vector such that the visual information for each pixel is effectively captured in a structured form. For instance, the respective 3D vector for each pixel may be represented as follows:

$$( H , W , 3 ) = [ H , W ( R , G , B ) ] \qquad ( 1 )$$

where H denotes the value for the y-axis position of the corresponding pixel, W denotes the value for the x-axis position of the corresponding pixel, and values for each of R, G, B denote absolute color codes. In some examples, the 3D array converter 160 further receives one or more optional image quality parameters 162 configured to refine image quality of the input KM image 50. Here, the image quality parameters 165 may include a contrast ratio input to enhance the visual clarity and distinction of image features in the graphical KM plot 200a contained in the input KM image 50. Additionally or alternatively, the image quality parameters 165 may include a display parameter that enables the original graphical KM plot 200a to be presented in the GUI 120 displayed on a screen 114 in communication with the client device 110. Thus, the user 10 may provide adjustments to the displayed original graphical KM plot 200a that may be instrumental in preparation of the input KM image 50 for the intricate process of KM curve digitization by the KM digitizer 150, ensuring that the subsequent steps S2-S7 operate on data optimized for both accuracy and efficiency.

A second step (S2) of the digitization process processes the respective 3D vectors represented by the 3D array 165 to assign one of four possible colors indicators to each pixel: zero (0) for black, one (1) for white, two (2) for colored, and three (3) for grey. This step is tasked with quantitatively analyzing information encoded within the colored pixels of the graphical KM plot 200a, thereby enabling the ability to programmatically “read” and “interpret” the KM image so that critical elements such as axes and curves can be accurately identified. As with other plots of two-dimensional curves, the KM plot 200a includes x- and y-axes delineating a plane that contains the curves 20. The ability to accurately locate the axes within the input image 50 enables the KM digitizer 150 to establish coordinates for points along each of the curves and to also isolate a minimal area containing the curves 20 for digitization, and thus, significantly mitigate the influence of noise. While the original KM plot 200a may contain additional information-ranging from image legends and median survival times to auxiliary lines these elements, although informative, do not contribute to the digitization of the curves and are thus considered noise.

Typically, the x-axis and y-axis are represented by the longest, continuous black lines parallel to edges of input KM image 50. Accordingly, the second step (S2) initially involves extracting all black pixels under the assumption that these pixels represent the axis lines. Here, a black pixel mask converter 170 is configured to generate a black pixel matrix mask 200b for the original graphical KM plot 200b by processing the 3D array 165 to convert all white pixels to pure white and all other pixels to pure black. That is, white pixels denote the background and black pixels typically represent the x- and y-axes. The black pixel matrix mask 200b includes dimensions that match the dimensions of the original graphical KM plot 200a. FIG. 2B shows an example of the black pixel matrix mask 200b generated by the black pixel mask converter 170 for the original graphical KM plot 200b.

On the other hand, a colored pixel mask converter 180 is configured to generate a colored pixel matrix mask 200c by processing the 3D array 165 to convert all black, grey, and white pixels to pure white. FIG. 2C shows an example of the colored pixel matrix mask 200c generated by the colored pixel mask converter 180 for the original graphical KM plot 200b. The colored pixel matrix mask 200c includes dimensions that match the dimensions of the original graphical KM plot 200c. Colored pixels correspond to the curves. FIG. 2C shows the colored pixel matrix mask 200c additionally including the number at risk data 220 since the underlying text includes one row of text in a same color as the first curve 20a (e.g., red) that indicates the number at risk values associated with the respective first group of subjects represented by the first curve 20a and another row of text in a same as the second curve 20b (e.g., blue) that indicates the number at risk values associated with the respective second group of subjects represented by the second curve 20b.

Notably, grey pixels within the 3D array 165 represent a complexity in that these pixels might signify noise due to poor image quality of the input KM image 50 or they might represent curves 20 in grey that require identification in subsequent steps. The challenge lies in the inherent imperfection of pixel color representation; black and white pixels rarely convert to the absolute (0, 0, 0) or (255, 255, 255) codes, necessitating a tolerance margin. A pixel is identified as black if its RGB values fall within a specified margin from 0, and similarly, as white if its RGB values are within a margin from 255. The KM digitizer may determine that a corresponding pixel is grey when the difference between the maximum and minimum RGB values falls below a threshold tolerance margin. These tolerance margins are user-defined. The KM digitizer 150 may receive threshold tolerance input values input by the user 10 such that the user 10 can define these values as needed. In a non-limiting example, the tolerance margins include default settings that place black pixels within RGB values ranging from 0-51, white pixels within RGB values ranging from 204-255, and grey with a threshold tolerance margin equal to 25. As such, the black pixel mask converter 170 converts all white pixels to pure white (255, 255, 255) and all other pixels to pure black (0, 0, 0) to provide the black pixel matrix mask 200b shown in FIG. 2B and the colored pixel mask converter 180 converts all black, grey, and white pixels to pure white (255, 255, 255) to provide the colored pixel matrix mask 200c shown in FIG. 2C. In subsequent steps, the black pixel matrix mask enables the digitization process to first identify the x-axis and y-axis of the KM plot and the colored pixel mask is instrumental for ultimately digitizing the KM curves in the original graphical KM plot.

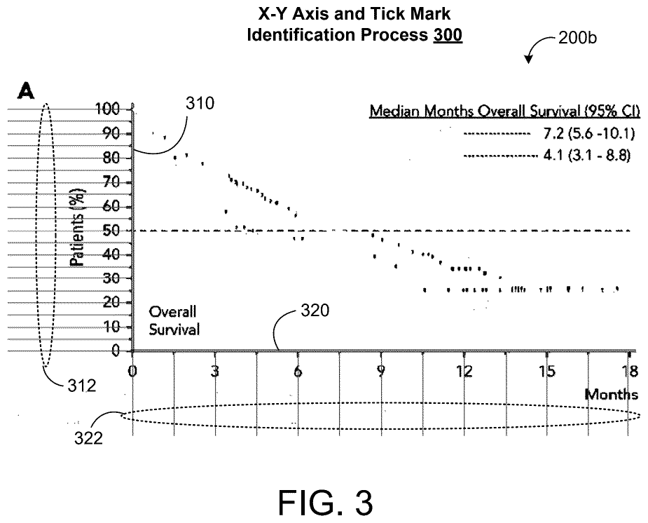

During a third step (S3) of the digitization process, the KM digitizer 150 uses a plot axis identifier 300 to process the black pixel matrix mask 200b to identify the x-axis 320 (FIG. 3) and the y-axis 310 (FIG. 3) of the original graphical KM plot 200a by locating the longest continuous black lines formed by the black pixels in the black pixel matrix mask 200b. FIG. 3 shows an example of the x-axis 320 and the y-axis 310 identified by the plot axis identifier 300 in the black pixel matrix mask 200b. Here, the longest continuous black line extending horizontally represents the x-axis 320 and the longest continuous black line extending vertically represents the y-axis 310. By default, the plot axis identifier 300 may select columns where over half of the elements are black, however, the user 10 may adjust this default setting to accommodate input KM images 50 with varying qualities and features, such as those with frame boxes at the edges which could potentially mislead the KM digitizer 50. Consequently, the plot axis identifier 300 may exclude the outermost columns (e.g., typically the rightmost ten columns) to avoid confusion with image borders.

Notably, the column within the black pixel matrix mask 200b that is richest in black pixels does not always correspond to the y-axis due to factors like input quality or the presence of noise and special curve features. Nonetheless, the y-axis is characterized by its continuity, guiding the plot axis identifier 300 to prioritize columns with the most extended stretches of connected elements. This focus on continuity helps mitigate errors from noise or breaks in the axis line. For instance, FIGS. 2B and 3 show the black pixel matrix mask 200b including a slight break in the line denoting the y-axis at the tick mark at the ‘100’ value. Despite disruptions in connectivity, the plot axis identifier enables the effective identification of the y-axis. Identification of the x-axis 320 follows a parallel procedure where the plot axis identifier scans the black pixel matrix mask 200b along the bottom-up to identify the longest horizontal line.

After the x-axis and the y-axis are identified, the plot axis identifier 300 is further configured to perform a one-dimensional (1D) clustering technique to identify and delineate tick marks 312 along the y-axis 310 and tick marks 322 along the x-axis 320. FIG. 3 shows the tick marks 312, 322 identified by the plot axis identifier 300 in the black pixel matrix mask 200b. The tick marks 312, 322 are not necessarily positioned at ends of the axis 310, 322, but aid in defining the digitization area and correlating pixel positions to an actual coordinate system of the original graphical KM plot 200a. The plot axis identifier 300 may output axis-tick mark coordinates 310, 312, 320, 322 depicting the positions of the x-axis, the y-axis, and the tick marks identified along both the x-axis and the y-axis. As shown in FIG. 3, the plot axis identifier 300 processes the black pixel matrix mask 200b to identify the tick marks 312 to the left of the y-axis 310 while the tick marks 322 are identified below the x-axis 320.

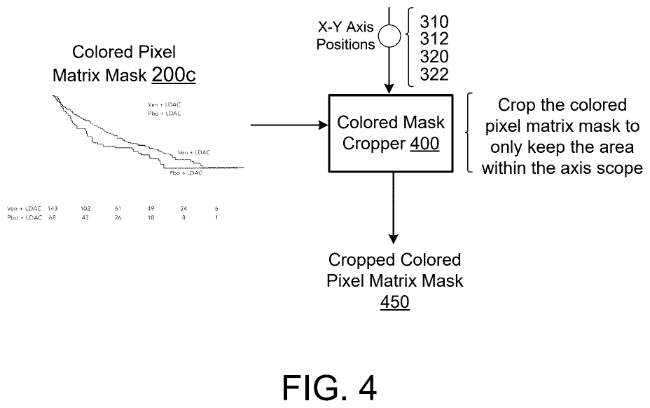

Referring to FIGS. 1 and 4, during a fourth step (S4) of the digitization process, the KM digitizer 150 employs a colored mask cropper 400 that receives, as input, the axis-tick mark coordinates 310, 312, 320, 322 output by the plot axis identifier 300 and the colored pixel matrix mask 200c generated by the colored pixel mask converter 180, and generates, as output, a cropped colored pixel matrix mask 450. Notably, as the second step of the digitization process generated both the colored pixel matrix mask 200c and the black pixel matrix mask 200b alongside one another, the dimensions of the original graphical KM plot 200a are preserved to allow for the seamless application of the x- and y-axes positions 320, 310 identified in the black pixel matrix mask 200b to the colored pixel matrix mask 200c. As such, the colored mask cropper 400 crops the colored pixel matrix mask 200c to retain only a region encompassed by the x- and y-axis positions. The cropped colored pixel matrix mask 450 exclusively contains the digitization-relevant colored KM curves 20. That is, a bottom left corner of the cropped colored pixel matrix mask 450 corresponds to an origin of the coordinate system, whereby all curves 20 initiating from the top-left corner of the cropped colored pixel matrix mask 450 are effectively positioned at (0, 100).

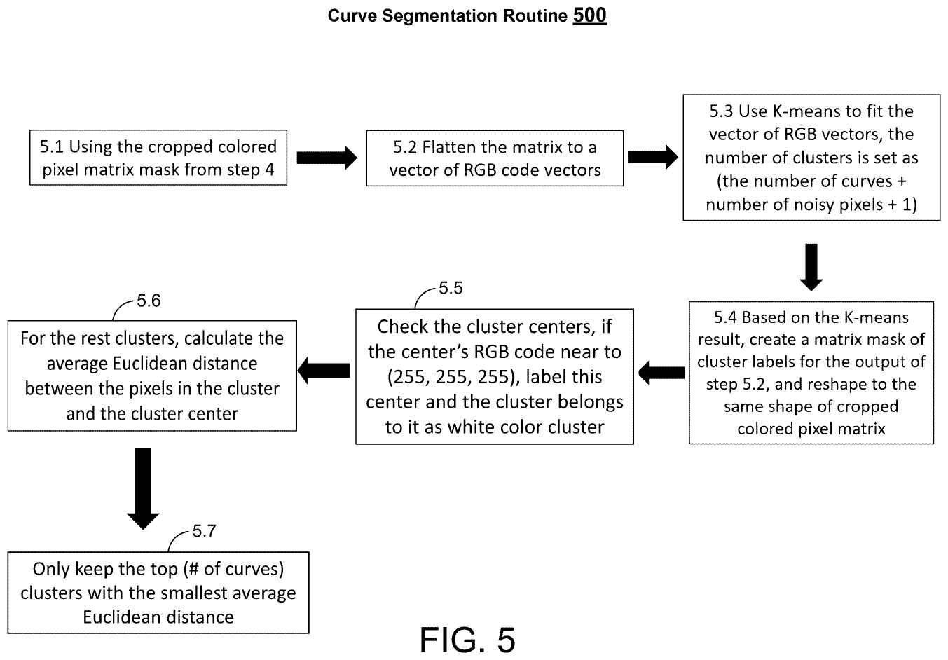

During a fifth step (S5) of the digitization process, the KM digitizer 150 executes a curve segmentation routine 500 to processes and flatten the cropped colored pixel matrix mask 450 into a vector of RGB code vectors and then uses K-means clustering for clustering the respective colors associated with the KM curves in the cropped colored pixel matrix mask into respective groups 510, 510a-b. FIG. 5 shows example sub-steps performed by the curve segmentation routine 500 during the fifth step (S5) of the digitization process. At sub-step 5.1, the routine 500 receives the cropped colored pixel matrix mask 450, and then at sub-step 5.2, flattens the cropped colored pixel matrix mask 450 into the vector of RGB code vectors. At sub-step 5.3, the routine 500 uses the K-means clustering to fit the vector of RGB vectors. Here, the routine 500 may receive K-means clustering parameters 182 (FIG. 1) that set the number of clusters to a value that is equal to the number of KM curves 20 present in the original graphical KM plot 200a incremented by one to account for the white background. Since the vector of RGB code vectors output at sub-step 5.2 encodes the colored pixels within the cropped colored pixel matrix mask 450, the K-means clustering is an efficient technique for grouping pixels of similar colors, thereby enabling the KM digitizer 150 to associate the respective groups of clustered pixels with their respective curves 20.

The curve segmentation routine 500 may require that a number of clusters be set equal to the number of KM curves present in the graphical KM plot incremented by one to account for the white background. The user 10 may adjust the set number of clusters to help mitigate impacts from noise present within the input KM image 50.

At sub-step 5.4, based on the K-means clustering, the routine 500 may create a matrix mask of cluster labels for the vector of RGB code vectors output at sub-step 5.2 and reshape the matrix mask to match a same shape of the cropped colored pixel matrix mask. Through K-means clustering, the curve segmentation routine 500 categorizes pixels from the cropped colored pixel matrix mask 450 into the distinct respective groups 510 with each respective group 510 of clustered pixels having a centroid that defines a general color of the pixels.

At sub-step 5.5, the curve segmentation routine 500 labels the centroid/center of the cluster having a corresponding RGB code near (255, 255, 255) as a white color centroid belonging to the respective group of white pixels. Here, the routine 500 may identify the group of clustered pixels representing the background based on the characteristics of this group typically having the largest number of clustered pixels and each of the clustered pixels having a color close to white.

At sub-step 5.6, for the remaining groups of clustered pixels, the curve segmentation routine 500 may distinguish these groups of clustered pixels that contain the pixels of actual KM curves from noise by comparing an average Euclidean distance between the pixels within the cluster and their clustered centroid (e.g., center). That is, groups having clustered pixels with a lower average Euclidean distance are indicative of actual KM curves, while those clusters having a higher variance are likely attributed to noise. As such, the curve segmentation routine 500 will output the top-N respective groups of clustered pixels having the smallest average Euclidean distance to represent each of the KM curves at sub-step 5.7. Here, “N” is equal to the number of KM curves in the graphical KM plot. Continuing with the example, the top-N respective groups of clustered pixels include the first respective group 510a of clustered pixels associated with the first curve 20a and having a first color (e.g., red) and the second respective group 510b of clustered pixels associated with the second curve 20b and having a second color (e.g., blue). The routine ensures that even when curves 20 within the original graphical KM plot 200a overlap or share similar color hues, they can be distinctly processed, preserving the integrity and accuracy of the digitization process

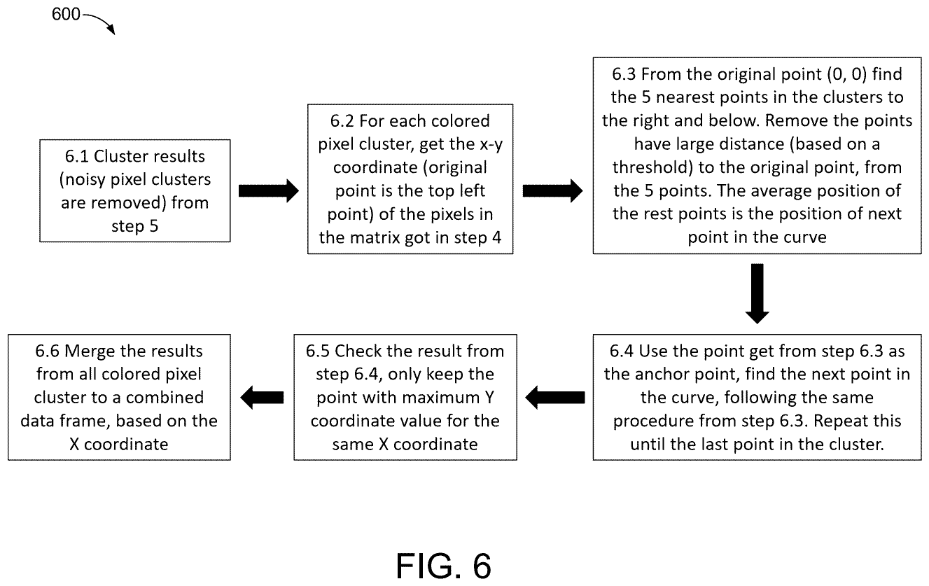

Referring to FIGS. 1 and 6, during a sixth step (S6) of the digitization process, the KM digitizer 150 executes a curve digitization routine 600 to perform a pixel-by-pixel analysis on each respective group 510a, 510b of clustered pixels segmented from the cropped colored pixel matrix mask 450 by the curve segmentation routine 500 to generate a respective digitized representation 610, 610a-b of the corresponding KM curve 20, 20a-20b represented by the respective group 510, 510a-b of clustered pixels. The curve digitization routine 600 includes multiple sub-steps 6.1-6.7. At sub-step 6.1, the routine 600 receives the respective colored groups 510 of clustered pixels and for each respective colored group 510 of clustered pixels, the routine 600 obtains the pixel coordinates from the cropped colored pixel matrix mask 450 at sub-step 6.2.

At sub-step 6.3, the curve digitization routine 600 assigns a top left pixel from the respective group 510 of clustered pixels as a reference origin point and then determines the position of each pixel in relation to this origin. Each pixel point of reference may serve as an anchor point. At sub-step 6.4, the curve digitization routine 600 identifies a predefined number of nearest pixels (e.g., 5 nearest pixels) to the anchor point that are within the same color group located to the right and below the anchor point. The predefined number of nearest pixels identified may be considered candidate points for the subsequent point of the corresponding KM curve, with those having distances from the anchor point exceeding an outlier threshold being excluded as outliers from the curve. The outlier threshold θ may be represented as follows:

$$θ = \frac{distance between the candidate point and anchor}{\sqrt{width of γ \times height of γ}} \qquad ( 2 )$$

where γ denotes the cropped colored pixel matrix mask 450. A candidate point may be deemed an outlier if its outlier threshold exceeds 0.1.

After exclusion of any outlier pixels, the positions of the remaining pixels may be averaged to establish the subsequent point on the corresponding KM curve. At sub-step 6.4, the routine 600 uses the subsequent point on the KM curve determined at sub-step 6.3 to serve as the anchor point such that the curve digitization process repeats sub-steps 6.3 and 6.4 in an iterative fashion to determine each point on the corresponding KM curve. Notably, when two or more points established along the same curve have a same x-coordinate value, the curve digitization routine 600 will retain only the point that is associated with a highest y-coordinate value at sub-step 6.5. Lastly, at sub-step 6.6, the curve digitization routine 600 merges the digitized results 610a, 610b from each respective colored group 510a, 510b of clustered pixels into a combined coordinate data frame 610 based on the x-coordinate positions. Here, the combined coordinate data frame 610 serves as a composite digitization representation of all the KM curves 20 in the original graphical KM plot 200a.

During final seventh step (S7) of the digitization process, a coordinate transferor 190 of the KM digitizer 150 receives, as input, the combined coordinate data frame 610, 610a-b (e.g., composite digitization representation of the KM curves) and the axis-tick mark coordinates 310, 312, 320, 322 identified by the plot axis identifier 300 during the third step, and applies a regression model 192 to generate, as output, the digitized KM plot 200d. FIG. 2D provides an example of the digitized KM plot 200d. More specifically, the coordinate transferor 190 applies a moving window regression technique to remove residual outliers that still persist in the combined coordinate data frame 610 so that the digitized KM plot is sufficiently robust. For each corresponding point in each digitized curve, a window encompassing up to 20 pixels before and 20 pixels after the corresponding point is analyzed by applying the regression model 192 to estimate a reference Y value for the corresponding point. The moving window regression technique may then aggregate the reference Y values by calculating a mean (μ_{diff}) and standard deviation (σ_{diff}) of discrepancies between the digitized Y values conveyed by the combined coordinate data frame 610 and their counterpart reference Y values. Here, outliers may be identified as those points whose deviation from the mean exceeds a threshold number of standard deviations (e.g., three standard deviations) (μ_{diff}±3 σ_{diff}). The regression model 190 may be based on the exponential decay survival model, thereby enabling employment of a linear regression approach upon logarithmic transformation of Y values.

The coordinate transferor 190 is further configured to ensure that the digitized curves 610a, 610b are monotonically decreasing by scrutinizing the digitized Y values by adjusting any point whose Y value is less than that of its predecessor by aligning it with a nearest preceding digitized Y value. This technique results in the culmination of converting the digitized coordinates back to their original scale. Here, the coordinate transferor 190 may derive starting and ending positions of the x- and y-axes from the axis-tick mark coordinates 310, 312, 320, 322, alongside minimum and maximum tick values for both of the x- and y-axes (Xₘᵢₙ, Xₘₐₓ, Yₘᵢₙ, Yₘₐₓ) from initial parameters, to apply the following representations for coordinate conversion:

$${length}_{γ} = {Y}_{last point} - {Y}_{first point} , \qquad ( 3 )$$

$${length}_{X} = {X}_{last point} - {X}_{first point} , \qquad ( 4 )$$

$${Y}_{real} = ( \frac{{length}_{Y} - {Y}_{digitized}}{{length}_{Y}} ) \cdot ( {Y}_{max} - {Y}_{min} ) + {Y}_{min} , \qquad ( 5 )$$

$${X}_{r e a l} = ( \frac{{X}_{digitized}}{{length}_{X}} ) \cdot ( {X}_{max} - {X}_{min} ) + {X}_{min} . \qquad ( 6 )$$

By using equations (3)-(6) to adjust the digitized curves 610a, 610b, the coordinate transferor 190 ensures that the final digitized KM plot 200d accurately reflects the original KM curves 20a, 20b in the original graphical KM plot 200a contained in the input KM image 50.

Referring back to FIG. 1, in some implementations, after the digitized KM plot 200d is generated by the KM digitizer 150, an independent patient data (IPD) extraction process 700 extracts IPD 750 using the digitized KM plot 200d generated by the KM digitizer 150 and the number at risk data 220 obtained from the original graphical KM plot 200a. The IPD extraction process 700 may execute on the remote system 140 and/or the client device 110. In some examples, a single software application executing on the remote system 140 and/or the client device 110 executes both the KM digitizer 150 and the IPD extraction process 700. In other examples, the KM digitizer 150 and the IPD extraction process 700 are associated with separate software applications each executable on the remote system 140 and/or the client device 110. The IPD data extraction process 700 may receive, as input, the digitized KM plot 200d generated by the KM digitizer 150 as well as the number at risk data 220 obtained from the original KM plot 200a, and generate, as output, a digitized IPD plot 200e that conveys the IPD 750 extracted from the digitized KM plot 200e. FIG. 2E provides an example of the digitized IPD plot 200e.

The IPD extraction process 700 receives the number at risk data 220 as a table having rows for each of the time point values incremented along the x-axis and columns for each respective group of subjects with the corresponding number at risk value for each respective group of subjects denoted in the corresponding row for each particular time point. That is, the number of rows may be equal to the number of successive time points conveyed by the number at risk data 220 in the original graphical KM plot 200a, while the number of columns may be equal to the number of distinct KM curves 20 each associated with the respective group of subjects. Alternatively, the table representing the number at risk data 220 may instead include columns for each time point and rows for each respective group of subjects without departing from the scope of the present disclosure.

In some examples, the IPD extraction process 700 uses the number at risk data 220 and the digitized KM plot 200d to ultimately extract IPD 750 indicating a median duration (e.g., months) of overall survival and a Confidence Interval (CI) as follows:
Group 1 (Vₑₙ+LDAC) corresponding to digitized KM curve 610a: (5.52-9.61); and
Group 2 (P_{bo}+LDAC) corresponding to digitized KM curve 610b: (3.10-8.13).
   Notably, the IPD 750 extracted by the IPD extraction process 700 from the digitized KM plot 200d closely aligns with the original IPD data represented in the original KM plot 200a (i.e., located in upper right corner of the graphical KM plot 200a of FIG. 2A):
Group 1 (Vₑₙ+LDAC) corresponding to original KM curve 20a: (5.6-10.1); and
Group 2 (P_{bo}+LDAC) corresponding to original KM curve 20b: (3.1-8.8).

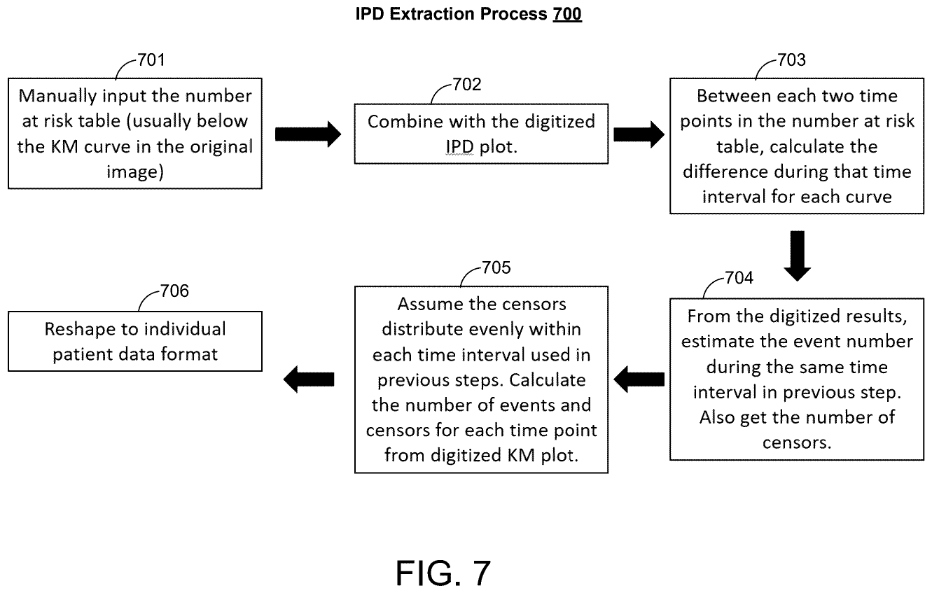

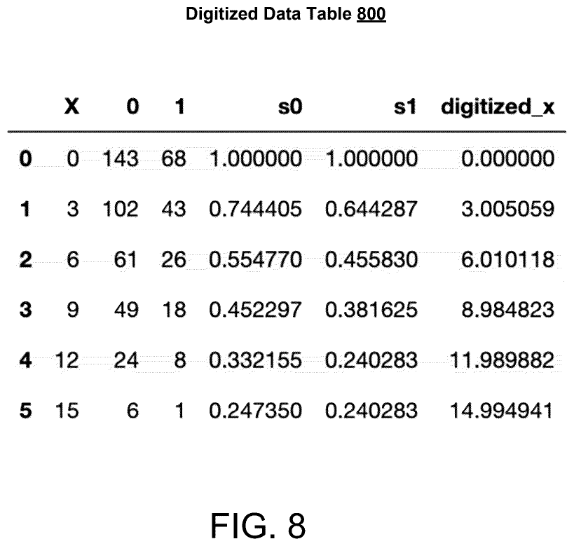

FIG. 7 is a flowchart of example steps 701-706 performed by the IPD extraction process 700 for extracting the IPD 750 from the final digitized KM plot 200d generated by the KM digitizer 150 and generating the digitized IPD plot 200e that conveys the IPD 750 extracted from the digitized KM plot 200d. At step 701, the extraction process receives the number at risk data 220 (i.e., the table representing the number at risk data 220 shown in FIG. 1), and at step 702, combines the number at risk data 220 with the digitized KM plot 200d. More specifically, step 702 combines the number at risk data 220 with digitized data conveyed in the digitized KM plot 200d that includes digitized x-values associated with corresponding digitized time points that are each paired with digitized y-values (e.g., digitized survival values s0, s1) for each digitized KM curve 610 associated with the respective group of subjects. FIG. 8 shows an example table 800 illustrating the digitized data conveyed in the digitized KM plot 200d that includes the respective digitized survival value s0, s1 (e.g., digitized y-values) associated with each of the digitized x-values (e.g., digitized time points) that are closest to the values of the corresponding time points (e.g., 0, 3, 6, 9, 12, 15 months) in the number at risk data 220.

In some examples, the number at risk data 220 is manually input by the user 10 via the GUI 120 executing on the client device 110. Here, the user 10 may identify the column names of the digitized KM plot 200e displayed in the GUI 120 based on the hex color code of the KM curves 20 represented in the original graphical KM plot 200a. In other examples, the KM digitizer 150 or the extraction process 700 processes the input KM image 50 by performing optical character recognition (OCR) or other image processing techniques to extract the number at risk data 220 from the original graphical KM plot 200a. In these examples, the user 10 may manually correct any incorrect values contained in the extracted number at risk data 220.

The table representing the number at risk data 220 may include each of the time points (e.g., 0, 3, 6, 9, 12, 15 months) depicted along the x-axis of the original graphical KM plot 200a, and for each KM curve 20 in the original graphical KM plot 200a, the table representing the number at risk data 220 further indicates a number of subjects/individuals that were still accounted for that have not yet experienced the event of interest at each of the time points. Therefore, the corresponding value for the number at risk at any of the particular time points will be equal to the total number of subjects/individuals remaining that have not experienced the event of interest or that are censored at the particular time point.

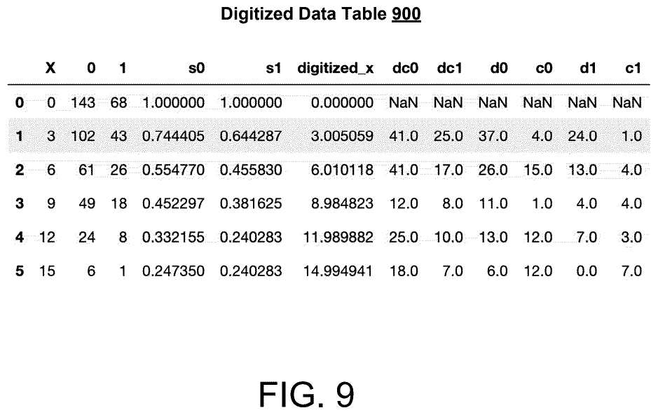

At step 703, for each KM curve associated with the respective group of subjects, the extraction process 700 determines a corresponding interval difference value between the number of subjects/individuals at each corresponding time point and the number of individuals at the immediately preceding time point. Notably, the IPD extraction process 700 leaves a difference value for the initial time point blank since there is no immediately preceding time point. Moreover, each pair of adjacent time points represents a corresponding time interval associated with both the corresponding interval difference value dc0, dc1 (FIG. 9) and a corresponding event value d0, d1 (FIG. 9) for each KM curve. For instance, a first time interval t₁ is defined between zero (0) and three (3) months, a second time interval t₂ is defined between three (3) and six (6) months, a third time interval t₃ is defined between six (6) and nine (9) months, a fourth time interval t₄ is defined between nine (9) and 12-months, and a fifth time interval t₅ is defined between 12 and 15-months. By way of example, for the first KM curve 20a shown in the KM plot 200a of FIG. 2A, the extraction process 700 determines/calculates that the corresponding interval difference value for the first time interval is equal to ‘41’ by subtracting the ‘102’ subjects/individuals present at 3-months from the ‘143’ subjects/individuals present at the beginning (e.g., 0-months). Similarly, for the second KM curve 20b shown in the KM plot 200a of FIG. 2A, the extraction process 700 determines/calculates that the corresponding interval difference value for the first time interval is equal to ‘25’ by subtracting the ‘43’ subjects/individuals present at 3-months from the ‘68’ subjects/individuals present at the beginning (e.g., 0-months). The extraction process 700 repeats calculating the corresponding interval difference value for the remaining time intervals for each of the first and second KM curves 20a, 20b. For each KM curve associated with the respective group of subjects, the corresponding interval difference value dcₜ determined/calculated for each corresponding time interval t is equal to the sum of a number of events dₜ and a number of censoring cₜ at the corresponding time interval based on the following equation:

$${dc}_{t} = {d}_{t} + {c}_{t} \qquad ( 7 )$$

At step 704, for each KM curve and each corresponding time point t, the IPD extraction process 700 determines a corresponding raw event value dₜ^{raw} based on the number of subjects/individuals at the immediately preceding time point Nₜ₋₁, the digitized survival value Sₜ (y-value) associated with the digitized x-value (e.g., digitized time point) that is closest to the value of the corresponding time point t, and the digitized survival value Sₜ₋₁ (y-value) associated with the digitized x-value that is closest to the value of the immediately preceding time point. More specifically, the IPD extraction process 700 may use the following equation to calculate the corresponding raw event value dₜ^{raw} for each KM curve and each corresponding time point t:

$${d}_{t}^{raw} = {N}_{t - 1} ( 1 - \frac{{S}_{t}}{{S}_{t - 1}} ) \qquad ( 8 )$$

For instance, and with reference to the digitized data table 800 of FIG. 8, the extraction process 700 determines/calculates a corresponding raw event value dₜ^{raw} that is equal to “36.55” for the second time point (e.g., 3-months) and the first KM curve 20a using a value of “143” for the number of subjects/individuals at the immediately preceding time point Nₜ₋₁, a value of “1” for the digitized survival value Sₜ₋₁ (y-value) associated with the digitized x-value that is closest to the value of the immediately preceding time point, and a value of “0.744405” for the digitized survival value Sₜ(y-value) associated with the digitized x-value (e.g., digitized time point) that is closest to the value of the corresponding time point t.

After obtaining the corresponding raw event value dₜ^{raw} for each KM curve and each corresponding time point from the number at risk table 220, the extraction process 700 further determines, at step 704, a corresponding value for the number of censorings cₜ and a corresponding value for the number of events value dₜ for each KM curve and each corresponding time point using the following equations:

$${c}_{t} = round ( {dc}_{t} - {d}_{t}^{raw} ) \qquad ( 9 )$$

$${d}_{+} = rounddown ( {dc}_{+} - {c}_{+} ) \qquad ( 10 )$$

For instance, and with reference to the digitized data table 800 of FIG. 8, the extraction process 700 determines/calculates a corresponding value for the number of censorings cₜ that is equal to “4” and a corresponding value for the number of events dₜ that is equal to “37” for the second time point (e.g., 3-months) and the first KM curve 20a using a value of “41” for the corresponding interval difference value dcₜ, and a value of “36.55” for the corresponding raw event value dₜ^{raw}. Notably, in the example above, a raw censoring value that is equal to “4.45” is first calculated and then rounded to obtain the value for the number of censorings that is equal to “4”. Accordingly, the extraction process 700 may update the digitization table 800 of FIG. 8 to further include the values for the interval difference dcₜ, the number of events dₜ, and the number of censorings cₜ at each of the time points for each KM curve. FIG. 9 shows an example table a depicting the additional digitized data obtained during steps 703 and 704 that includes the corresponding interval difference value dc0, dc1, the corresponding value for the number of events d0, d1, and the corresponding value for the number of censorings c0, c1 at each of the digitized x-values (e.g., digitized time points) that are closest to the values of the corresponding time points (e.g., 0, 3, 6, 9, 12, 15 months) in the number at risk data 220.

After performing step 704 to obtain the number of events dt and the number of censorings for each KM curve and each time point, only the total number of censorings that occur during each interval is known. In order to determine when the censorings occurred during each time interval from the number at risk data 220, the IPD extraction process 700 assumes that the censorings distribute evenly over each time interval in order to obtain the censoring time. Accordingly, for each KM curve and each time point, the IPD extraction process 700 determines/calculates, at step 705, a corresponding raw number at risk value Nᵢ, a corresponding raw event number value dᵢ^{raw}, a corresponding raw accumulated event number value dᵢ^{intAccum}, and a corresponding value for the number of events dᵢ using the following equations:

$${N}_{i} = {N}_{i - 1} - {c}_{i - 1} - {d}_{i - 1} \qquad ( 11 )$$

$${d}_{i}^{raw} = {N}_{i} ( 1 - \frac{{s}_{i}}{{s}_{i - 1}} ) \qquad ( 12 )$$

$${d}_{i}^{int Accum} = int ( {\sum }_{j = 0}^{i} {d}_{j}^{raw} ) \qquad ( 13 )$$

$${d}_{i} = {d}_{i}^{i n t A c c u m} - {d}_{i - 1}^{i n t A c c u m} \qquad ( 14 )$$

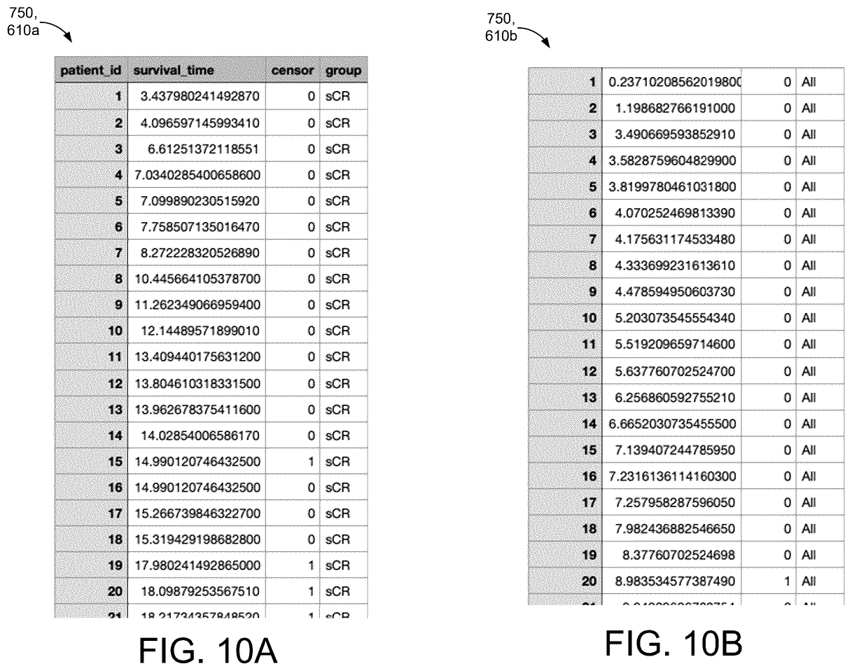

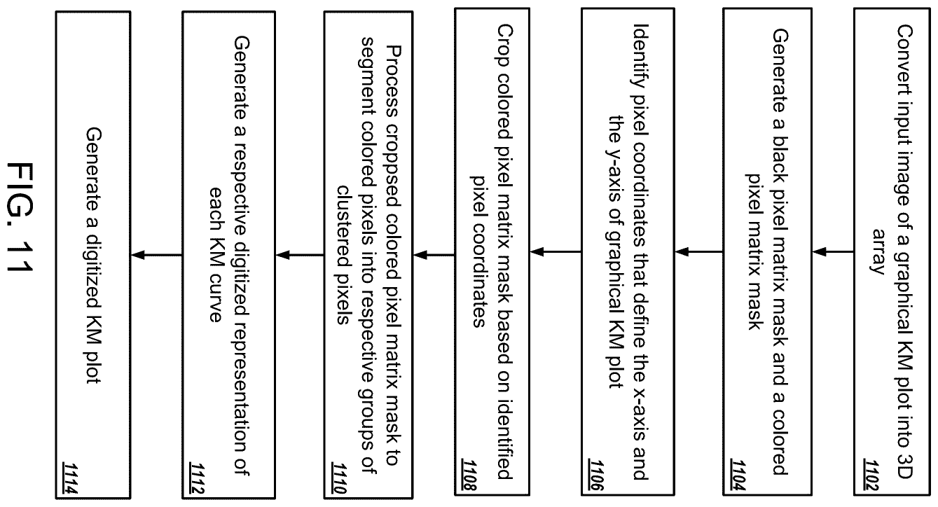

After calculating the corresponding value for the number of events dᵢ at the corresponding time point, the extraction process 700 may update the corresponding raw event number value dᵢ^{raw} at the corresponding time point using the corresponding value for the number events dᵢ calculated using Equation (14) and the corresponding value for the number of censors cᵢ. Moreover, in the event there is a mismatch where the raw number at risk value Nᵢ is greater than the real number at risk from the number at risk data 220 at the corresponding time step, the IPD extraction process simply adds the difference between the raw number at risk value and the real number at risk value to the value for the number of events at the immediately preceding time point dᵢ₋₁. On the other hand, when there is a mismatch where the raw number at risk value Nᵢ is less than the real number at risk from the number at risk data 220 at the corresponding time step, the IPD extraction process 700 will subtract the difference between the raw number at risk value and the real number at risk value from the value for the number of censors at the immediately preceding time point cᵢ₋₁ first and then from the value for the number of events at the immediately preceding time point dᵢ₋₁ until the raw number at risk value matches the real number at risk. The IPD 750 extracted from the digitized KM plot 200d using the number at risk data 220 may include for each corresponding KM curve 20, the survival time for each subject/individual in the respective group represented by the corresponding KM curve 20 and whether the subject/individual was censored. FIGS. 10A and 10B show example tables of the IPD 750 for the first group of subjects/individuals represented by the first digitized KM curve 610a (FIG. 10A) and for the second group of subjects/individuals represented by the second digitized KM curve 610b (FIG. 10B).

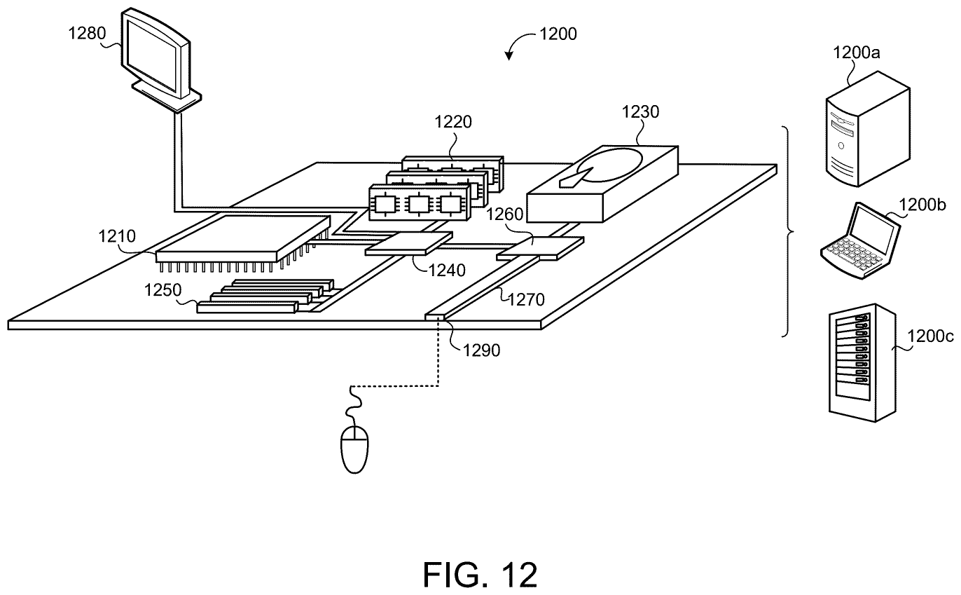

FIG. 11 provides a flowchart of an example arrangement of operations for a method 1100 of automating digitization of Kaplan-Meier (KM) curves 20 contained in an input image 50. form. The method 1100 may execute on data processing hardware 1210 (FIG. 12) based on instructions stored on memory hardware 1220 (FIG. 12) that cause the data processing hardware 1210 to perform the operations. The data processing hardware 1210 and the memory hardware 1220 may include the data processing hardware 144 and the memory hardware 146 of the remote system 140. Additionally or alternatively, the data processing hardware 1210 and the memory hardware 1220 may reside on the client device 110.

At operation 1102, the method 1100 includes receiving an input image 50 containing a graphical KM plot 200a of one or more KM curves 20 and processing the input image 50 to convert the graphical KM plot 200a into a three-dimensional (3D) array 165 representing a color of each pixel from the graphical KM plot 200a by a respective 3D vector.

At operation 1104, the method 1100 includes processing the 3D array 165 to generate: a black pixel matrix mask 200b by converting all white pixels to pure white and all other pixels to pure black; and a colored pixel matrix mask 200c by converting all black, grey, and white pixels to pure white.

At operation 1106, the method 1100 includes processing the black pixel matrix mask 200b to identify pixel coordinates 310, 320 that define the x-axis and the y-axis of the graphical KM plot 200a. At operation 1108, the method 1100 includes cropping the colored pixel matrix mask 200c based on the identified pixel coordinates 310, 320 that define the x-axis and the y-axis of the graphical KM plot 200a.

At operation 1110, the method 1100 includes processing the cropped colored pixel matrix to segment the colored pixels from the cropped colored pixel matrix mask into respective groups of clustered pixels. At operation 1112, the method 1100 includes processing each respective group of clustered pixels that represents a corresponding KM curve 20 of the graphical KM plot 200a to generate a respective digitized representation 610 of the corresponding KM curve 20. At operation 1114, the method includes generating a digitized KM plot 200d based on the identified pixel coordinates and the respective digitized representation 610 generated for each corresponding KM curve 20 of the graphical KM plot 200a.

FIG. 12 is schematic view of an example computing device 1200 that may be used to implement the systems and methods described in this document. The computing device 1200 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 1200 includes a processor 1210, memory 1220, a storage device 1230, a high-speed interface/controller 1240 connecting to the memory 1220 and high-speed expansion ports 1250, and a low speed interface/controller 1260 connecting to a low speed bus 1270 and a storage device 1230. Each of the components 1210, 1220, 1230, 1240, 1250, and 1260, are interconnected using various busses, and may be mounted on a common motherboard or in other manners as appropriate. The processor 1210 can process instructions for execution within the computing device 1200, including instructions stored in the memory 1220 or on the storage device 1230 to display graphical information for a graphical user interface (GUI) on an external input/output device, such as display 1280 coupled to high speed interface 1240. In other implementations, multiple processors and/or multiple buses may be used, as appropriate, along with multiple memories and types of memory. Also, multiple computing devices 1200 may be connected, with each device providing portions of the necessary operations (e.g., as a server bank, a group of blade servers, or a multi-processor system).

The memory 1220 stores information non-transitorily within the computing device 1200. The memory 1220 may be a computer-readable medium, a volatile memory unit(s), or non-volatile memory unit(s). The non-transitory memory 1220 may be physical devices used to store programs (e.g., sequences of instructions) or data (e.g., program state information) on a temporary or permanent basis for use by the computing device 1200. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 1230 is capable of providing mass storage for the computing device 1200. In some implementations, the storage device 1230 is a computer-readable medium. In various different implementations, the storage device 1230 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer- or machine-readable medium, such as the memory 1220, the storage device 1230, or memory on processor 1210.

The high speed controller 1240 manages bandwidth-intensive operations for the computing device 1200, while the low speed controller 1260 manages lower bandwidth-intensive operations. Such allocation of duties is exemplary only. In some implementations, the high-speed controller 1240 is coupled to the memory 1220, the display 1280 (e.g., through a graphics processor or accelerator), and to the high-speed expansion ports 1250, which may accept various expansion cards (not shown). In some implementations, the low-speed controller 1260 is coupled to the storage device 1230 and a low-speed expansion port 1290. The low-speed expansion port 1290, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 1200 may be implemented in a number of different forms, as shown in the figure. For example, it may be implemented as a standard server 1200a or multiple times in a group of such servers 1200a, as a laptop computer 1200b, or as part of a rack server system 1200c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

What is claimed is:

1. A computer-implemented method executed on data processing hardware that causes the data processing hardware to perform operations comprising:
receiving an input image containing a graphical Kaplan-Meier (KM) plot of one or more KM curves, the graphical KM plot having an x-axis and a y-axis orthogonal to the x-axis;
processing the input image to convert the graphical KM plot into a three-dimensional (3D) array representing a color of each pixel from the graphical KM plot by a respective 3D vector;
processing the 3D array to generate:
a black pixel matrix mask by converting all white pixels to pure white and all other pixels to pure black; and
a colored pixel matrix mask by converting all black, grey, and white pixels to pure white;
processing the black pixel matrix mask to identify pixel coordinates that define the x-axis and the y-axis of the graphical KM plot;
cropping the colored pixel matrix mask based on the identified pixel coordinates that define the x-axis and the y-axis of the graphical KM plot;
processing the cropped colored pixel matrix mask to segment the colored pixels from the cropped colored pixel matrix mask into respective groups of clustered pixels, each respective group of clustered pixels associated with a different respective color;
processing each respective group of clustered pixels that represents a corresponding KM curve of the one or more KM curves of the graphical KM plot to generate a respective digitized representation of the corresponding KM curve; and
generating a digitized KM plot based on the identified pixel coordinates that define the x-axis and the y-axis of the graphical KM plot and the respective digitized representation generated for each corresponding KM curve of the one or more KM curves of the graphical KM plot.

2. The method of claim 1, wherein the cropped colored pixel matrix mask retains only a region of the graphical KM plot that is encompassed by the positions of the x-axis and the y-axis so that the cropped colored pixel matrix exclusively contains the one or more KM curves of the graphical KM plot.

3. The method of claim 1, wherein the operations further comprise processing each respective group of clustered pixels to identify which respective group of clustered pixels represent a background of the graphical KM plot and which one or more respective groups of clustered pixels represent corresponding ones of the one or more KM curves of the graphical KM plot.

4. The method of claim 1, wherein processing the black pixel matrix mask to identify pixel coordinates that define the x-axis and the y-axis of the graphical KM plot further comprises processing the black pixel matrix mask to identify and delineate tick mark positions along both the x-axis and the y-axis of the graphical KM plot.

5. The method of claim 4, wherein generating the digitized KM plot is further based on the tick mark positions identified and delineated along both the x-axis and the y-axis of the graphical KM plot.

6. The method of claim 1, wherein processing the cropped colored pixel matrix to segment the colored pixels from the cropped colored pixel matrix mask into respective groups of clustered pixels comprises:
flattening the cropped colored pixel matrix mask into a vector of color code vectors; and
processing the vector of color code vectors using a K-means clustering for clustering the respective colors associated with the one or more KM curves into the respective groups of clustered pixels.

7. The method of claim 6, wherein each respective group of clustered pixels has a centroid defining the different respective color associated with the pixels in the respective group of clustered pixels.

8. The method of claim 7, wherein processing each respective group of clustered pixels that represents the corresponding KM curve of the one or more KM curves of the graphical KM plot comprises:
determining an average Euclidean distance between the pixels within the respective group of clustered pixels;
identifying a top-N respective groups of clustered pixels having the lowest average Euclidean distances to represent each of the one or more KM curves; and
processing the top-N respective groups of clustered pixels to generate the respective digitized representation of each corresponding KM curve of the one or more KM curves.

9. The method of claim 8, wherein N is equal to a number of the one or more KM curves of the graphical KM plot.

10. The method of claim 1, wherein generating the digitized KM plot comprises, for each corresponding pixel point in the respective digitized representation generated for the corresponding KM curve:
applying a regression model over a window encompassing a predetermined number pixels before and a the predetermined number of pixels after the corresponding pixel point to estimate a reference y value for the corresponding pixel point;
calculating a mean and standard deviation of discrepancies between the reference y value and the counterpart digitized y value extracted from the respective digitized representation; and
removing the corresponding pixel point from the respective digitized representation when the standard deviation from the mean exceeds a threshold number of standard deviations.

11. The method of claim 1, wherein the operations further comprise executing an independent patient data (IPD) extraction process that uses number at risk data obtained from the graphical KM plot to extract IPD from the digitized KM plot.

12. The method of claim 11, wherein the operations further comprise generating a digitized IPD plot that conveys the IPD extracted from the digitized KM plot.

13. The method of claim 1, wherein each KM curve of the one or more KM curves of the graphical KM plot depicts survival probability over time for a respective group of subjects.

14. A system comprising:
data processing hardware; and
memory hardware in communication with the data processing hardware, the memory hardware storing instructions that when executed on the data processing hardware cause the data processing hardware to perform operations comprising:
receiving an input image containing a graphical Kaplan-Meier (KM) plot of one or more KM curves, the graphical KM plot having an x-axis and a y-axis orthogonal to the x-axis;
processing the input image to convert the graphical KM plot into a three-dimensional (3D) array representing a color of each pixel from the graphical KM plot by a respective 3D vector;
processing the 3D array to generate:
a black pixel matrix mask by converting all white pixels to pure white and all other pixels to pure black; and
a colored pixel matrix mask by converting all black, grey, and white pixels to pure white;
processing the black pixel matrix mask to identify pixel coordinates that define the x-axis and the y-axis of the graphical KM plot;
cropping the colored pixel matrix mask based on the identified pixel coordinates that define the x-axis and the y-axis of the graphical KM plot;
processing the cropped colored pixel matrix mask to segment the colored pixels from the cropped colored pixel matrix mask into respective groups of clustered pixels, each respective group of clustered pixels associated with a different respective color;
processing each respective group of clustered pixels that represents a corresponding KM curve of the one or more KM curves of the graphical KM plot to generate a respective digitized representation of the corresponding KM curve; and
generating a digitized KM plot based on the identified pixel coordinates that define the x-axis and the y-axis of the graphical KM plot and the respective digitized representation generated for each corresponding KM curve of the one or more KM curves of the graphical KM plot.

15. The system of claim 14, wherein the cropped colored pixel matrix mask retains only a region of the graphical KM plot that is encompassed by the positions of the x-axis and the y-axis so that the cropped colored pixel matrix exclusively contains the one or more KM curves of the graphical KM plot.

16. The system of claim 14, wherein the operations further comprise processing each respective group of clustered pixels to identify which respective group of clustered pixels represent a background of the graphical KM plot and which one or more respective groups of clustered pixels represent corresponding ones of the one or more KM curves of the graphical KM plot.

17. The system of claim 14, wherein processing the black pixel matrix mask to identify pixel coordinates that define the x-axis and the y-axis of the graphical KM plot further comprises processing the black pixel matrix mask to identify and delineate tick mark positions along both the x-axis and the y-axis of the graphical KM plot.

18. The system of claim 17, wherein generating the digitized KM plot is further based on the tick mark positions identified and delineated along both the x-axis and the y-axis of the graphical KM plot.

19. The system of claim 14, wherein processing the cropped colored pixel matrix to segment the colored pixels from the cropped colored pixel matrix mask into respective groups of clustered pixels comprises:
flattening the cropped colored pixel matrix mask into a vector of color code vectors; and
processing the vector of color code vectors using a K-means clustering for clustering the respective colors associated with the one or more KM curves into the respective groups of clustered pixels.

20. The system of claim 19, wherein each respective group of clustered pixels has a centroid defining the different respective color associated with the pixels in the respective group of clustered pixels.

21. The system of claim 20, wherein processing each respective group of clustered pixels that represents the corresponding KM curve of the one or more KM curves of the graphical KM plot comprises:
determining an average Euclidean distance between the pixels within the respective group of clustered pixels;
identifying a top-N respective groups of clustered pixels having the lowest average Euclidean distances to represent each of the one or more KM curves; and
processing the top-N respective groups of clustered pixels to generate the respective digitized representation of each corresponding KM curve of the one or more KM curves.

22. The system of claim 21, wherein N is equal to a number of the one or more KM curves of the graphical KM plot.

23. The system of claim 14, wherein generating the digitized KM plot comprises, for each corresponding pixel point in the respective digitized representation generated for the corresponding KM curve:
applying a regression model over a window encompassing a predetermined number pixels before and a the predetermined number of pixels after the corresponding pixel point to estimate a reference y value for the corresponding pixel point;
calculating a mean and standard deviation of discrepancies between the reference y value and the counterpart digitized y value extracted from the respective digitized representation; and
removing the corresponding pixel point from the respective digitized representation when the standard deviation from the mean exceeds a threshold number of standard deviations.

24. The system of claim 14, wherein the operations further comprise executing an independent patient data (IPD) extraction process that uses number at risk data obtained from the graphical KM plot to extract IPD from the digitized KM plot.

25. The system of claim 24, wherein the operations further comprise generating a digitized IPD plot that conveys the IPD extracted from the digitized KM plot.

26. The system of claim 14, wherein each KM curve of the one or more KM curves of the graphical KM plot depicts survival probability over time for a respective group of subjects.
